(19) United States
(12) Patent Application Publication
(10) Pub. No.: US 2009/0189946 A1
(43) Pub. Date: Jul. 30, 2009

(54) LIQUID EJECTING APPARATUS

(75) Inventor: Hiroshi Taira, Ichinomiya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/359,282

(22) Filed: Jan. 23, 2009

(30) Foreign Application Priority Data
Jan. 29, 2008 (JP) 2008-017315

(51) Int. Cl. B41J 2/165

(52) U.S. Cl. 347/33

(57) ABSTRACT

A liquid delivering apparatus including: a liquid ejecting head having an ejection surface; a maintenance unit including a roller, a sheet member having a liquid receiving section; a sheet-member moving mechanism configured to move the sheet member; and a wiper configured to wipe the ejection surface while moving in a first direction; and a maintenance-unit moving mechanism configured to move the maintenance unit between a maintenance position and a retracted position; a maintenance-unit controller configured to control the maintenance-unit moving mechanism to move the maintenance unit; and a sheet-member-movement controller configured to control the sheet-member moving mechanism to move the liquid receiving section between a receive position and a non-receive position at the maintenance position, wherein, when the maintenance unit is located at the maintenance position, the liquid receiving section is moved from the receive position to the non-receive position without being covered with the sheet member per se while the wiper wipes the liquid ejection region.

### CROSS REFERENCE TO RELATED APPLICATION

The present application claims priority from Japanese Patent Application No. 2008-017315 which was filed on Jan. 29, 2008, the disclosure of which is herein incorporated by reference to its entirety.

### BACKGROUND OF THE INVENTION

1. Field of the Invention

The present invention relates in general to a liquid ejecting apparatus including a liquid ejecting head which ejects a liquid.

2. Description of the Related Art

There is known an ink-jet recording apparatus having: an ink receiving sheet disposed so as to be reciprocated in a space between a conveyer device and a recording head in a direction perpendicular to a conveyance direction in which a recording medium is conveyed; and a sheet moving mechanism configured to move the ink receiving sheet to a prescribed position. In the above-indicated ink-jet recording apparatus, when a purging operation is performed, the ink receiving sheet accommodated in a wound or rolled state is pulled or drawn out between the recording head and the conveyor device, and the ink ejected from the recording head is received by the ink receiving sheet. After the ink receiving sheet has received the ink, the sheet moving mechanism moves the ink receiving sheet such that the ink receiving sheet is accommodated in the wound or rolled state. On this occasion, the ink attached to a front surface of the ink receiving sheet is removed by an ink removing roller.

In the ink-jet recording apparatus indicated above, when the ink receiving sheet to which the ink is attached is accommodated in the wound or rolled state, the ink is removed from the ink receiving sheet by the ink removing roller. In a case where the ink remains on the front surface of the ink receiving sheet without being completely removed by the ink removing roller, the ink may become thickened or solidified between the front surface and a back surface of the rolled or wound ink receiving sheet, so that the front surface and the back surface of the ink receiving sheet undesirably stick to each other. Where the front surface and the back surface of the ink receiving sheet stick to each other due to the remaining ink that has become thickened or solidified, the ink receiving sheet in the wound or rolled state cannot be unwound or unrolled when the sheet moving mechanism operates to pull or draw the ink receiving sheet between the recording head and the conveyor device. Accordingly, the ink receiving sheet cannot be pulled or drawn between the recording head and the conveyor device.

### SUMMARY OF THE INVENTION

A need has arisen for a liquid ejecting apparatus capable of obviating operation failure of a sheet member.

According to one embodiment herein, a liquid ejecting apparatus may comprise: a liquid ejecting head having an ejection surface in which is formed a liquid ejection region that includes a plurality of ejection openings through which a liquid is ejected; a maintenance unit including: a roller rotatable about a rotational axis which is parallel to the ejection surface; a sheet member wound around the roller and having a liquid receiving section by which the liquid ejected from the plurality of ejection openings is received; a sheet-member moving mechanism configured to move the sheet member; and a wiper which protrudes from an outer surface of the sheet member and which is configured to wipe the ejection surface while moving in a first direction that is parallel to the ejection surface, in accordance with a movement of the sheet member; and a maintenance-unit moving mechanism configured to move the maintenance unit between (a) a maintenance position at which the liquid receiving section is capable of facing the ejection surface and (b) a retracted position at which the liquid receiving section is not capable of facing the ejection surface; a maintenance-unit controller configured to control the maintenance-unit moving mechanism such that the maintenance unit is moved between the maintenance position and the retracted position; and a sheet-member-movement controller configured to control the sheet-member moving mechanism such that the liquid receiving section of the sheet member is moved between a receive position at which the liquid receiving section faces the liquid ejection region and a non-receive position at which the liquid receiving section does not face the liquid ejection region, when the maintenance unit is located at the maintenance position, wherein, when the maintenance unit is located at the maintenance position, the liquid receiving section is moved from the receive position to the non-receive position without being covered with the sheet member per se while the wiper wipes the liquid ejection region.

In the liquid ejecting apparatus constructed as described above, the liquid receiving section is not covered with the sheet member per se even when the sheet member is moved from the receive position to the non-receive position after having received, at the receive position, the liquid ejected from the ejection openings. Accordingly, the liquid attached to the liquid receiving section does not attach to an inner surface of other sections of the sheet member except the liquid receiving section, thereby obviating operation failure of the sheet member.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a schematic side elevational view in cross section showing an ink-jet printer as a liquid ejecting apparatus according to a first embodiment;

FIG. 2 is a plan view showing a part of the ink-jet printer of FIG. 1;

FIG. 3 is a cross-sectional view taken along line III-III of FIG. 2;

FIG. 4 is a plan view of a head unit as viewed from the bottom;

FIG. 5 is a schematic side elevational view of a maintenance unit and its vicinity;

FIG. 6A is a side elevational view of a wiping member and FIGS. 6B and 6C are views each for explaining a wiping operation in which the wiping member wipes an ink ejection surface;

FIG. 7 is a schematic block diagram showing a construction of a controller;

FIGS. 8A-8D are views chronologically showing a purging operation performed on ink-jet heads and a first wiping operation in which the ink ejection surfaces and bottom surfaces of filler plates are wiped;

FIGS. 9A-9B are views chronologically showing a second wiping operation in which the ink ejection surfaces and the bottom surfaces of the filler plates are again wiped after the first wiping operation;

FIG. 10A is a plan view of a maintenance unit according to a second embodiment of the invention and FIG. 10B is a cross-sectional view taken along line X-X of FIG. 10A;

FIG. 11 is schematic block diagram showing a construction of a controller according to the second embodiment; and

FIGS. 12A-12C are views chronologically showing a purging operation performed on the ink-jet heads and a wiping operation in which the ink ejection surfaces and the bottom surfaces of the filler plates are wiped.

### DETAILED DESCRIPTION OF THE EMBODIMENTS

Referring to the drawings, there will be explained embodiments of the present invention.

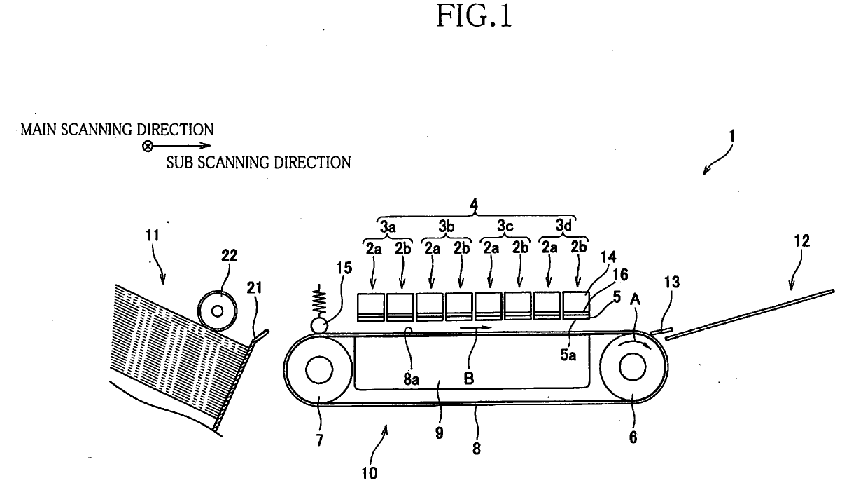

As shown in FIG. 1, an ink-jet printer 1 as a liquid ejecting apparatus is a color ink-jet printer including a head unit 4 which has four head pairs 3a-3d each consisting of two ink-jet heads 2a, 2b each as a liquid ejecting head. The ink-jet printer 1 includes a sheet feeding mechanism 11 disposed on its left side as seen in FIG. 1 and a sheet discharging portion 12 disposed on its right side as seen in FIG. 1.

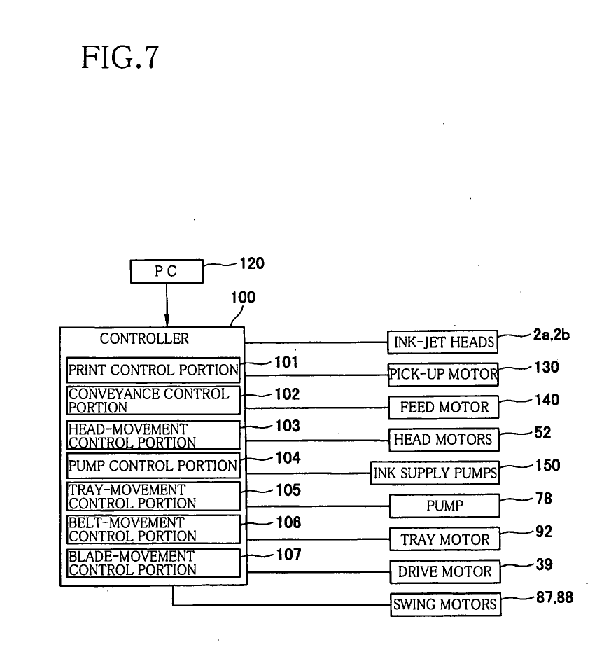

Inside the ink-jet printer 1, there is formed a sheet conveying path through which a recording sheet is conveyed from the sheet feeding mechanism 11 to the sheet discharging portion 12. The sheet feeding mechanism 11 has a pick-up roller 22. When a pick-up motor 130 (FIG. 7) is driven, the pick-up roller 22 is rotated so as to feed an uppermost one of the recording sheets accommodated in a sheet tray 21 from the left to the right in FIG. 1. A sheet conveying mechanism 10 is disposed in the middle of the sheet conveying path. The sheet conveying mechanism 10 is configured to convey the recording sheet in a sub scanning direction (as a second direction), namely, in a sheet-conveyance direction B, and includes a pair of belt rollers 6, 7 and an endless conveyor belt 8 that is wound around the belt rollers 6, 7 so as to be stretched therebetween.

The conveyor belt 8 has a sheet conveying surface 8a treated with silicone to give adhesion property thereto. A pressing roller 15 is disposed immediately downstream of the sheet feeding mechanism 11 so as to face the belt roller 7 with the conveyor belt 8 interposed therebetween. The pressing roller 15 is configured to press each sheet fed from the sheet feeding mechanism 11 onto the sheet conveying surface 8a of the conveyor belt 8. The sheet pressed onto the sheet conveying surface 8a is retained on the same 8a owing to the adhesion property thereof and is conveyed in the sheet-conveyance direction B. In this instance, the belt roller 6 disposed at a downstream portion of the ink-jet printer 1 in the sheet-conveyance direction is being rotated clockwise, i.e., in a direction indicated by an arrow A in FIG. 1, by a drive force transmitted from a feed motor 140 (FIG. 7).

A separation plate 13 is disposed immediately downstream of the conveyor belt 8 in the sheet-conveyance direction. The separation plate 13 is configured to separate the sheet retained on the sheet conveying surface 8a of the conveyor belt 8 therefrom and convey the separated sheet to the sheet discharging portion 12.

A platen 9 having a generally rectangular parallelepiped shape is disposed in a region enclosed by the conveyor belt 8. The platen 9 is held in contact with a lower surface of the conveyor belt 8 at a position where the platen 9 faces the ink-jet heads 2a, 2b, whereby the platen 9 supports the conveyor belt 8 from its inside.

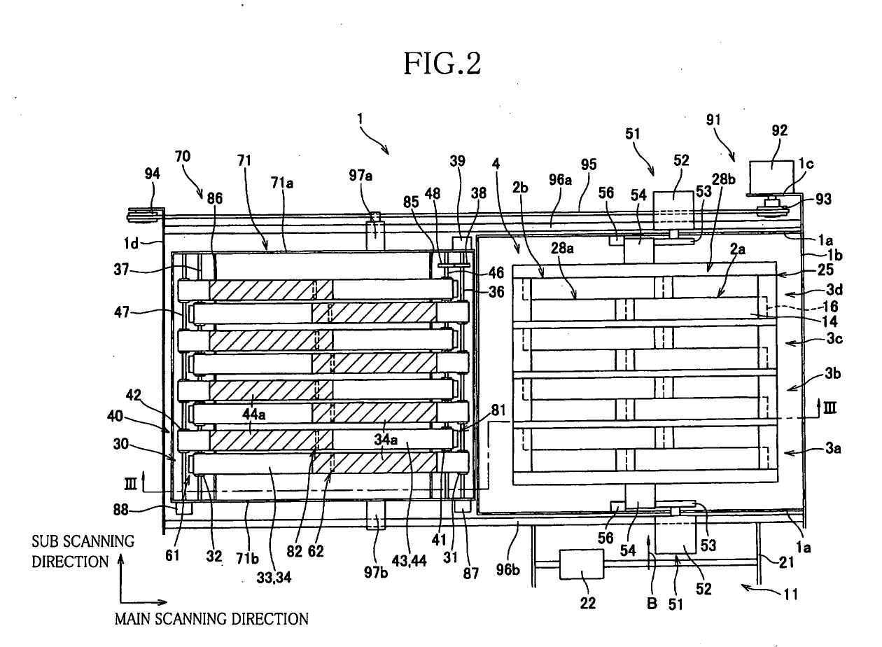

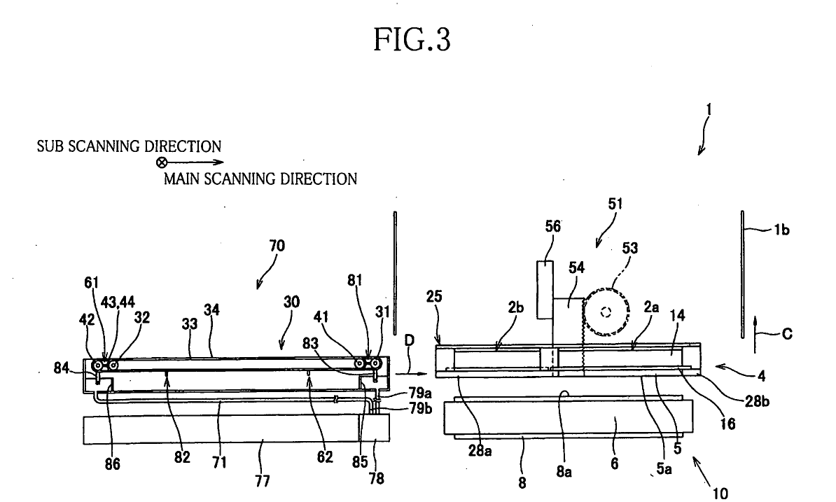

As shown in FIGS. 2-4, the head unit 4 includes the four head pairs 3a-3d, eight filler plates 28a, 28b each as a plate member, and a support frame 25 that supports the head pairs 3a-3d and the eight filler plates 28a, 28b. Each of the ink-jet heads 2a, 2b in each of the head pairs 3a-3d has a generally rectangular parallelepiped shape which is long in a main scanning direction (as a first direction) perpendicular to the sub scanning direction. As shown in FIG. 3, each of the ink-jet heads 2a, 2b has a head body 5 at its lower end.

As shown in FIG. 3, there is fixed, on an upper surface of each head body 5, a reservoir unit 16 which is partially covered with a cover 14 and in which ink is temporarily stored. The reservoir unit 16 has a dimension as measured in the main scanning direction that is longer than that of the head body 5. The reservoir unit 16 has extended portions at its longitudinal opposite ends in the main scanning direction and is fixed, at the extended portions, between the support frame 25 and the corresponding filler plate 28a, 28b. The support frame 25 is configured to be movable in a vertical direction by a pair of support-frame moving mechanisms 51 explained below.

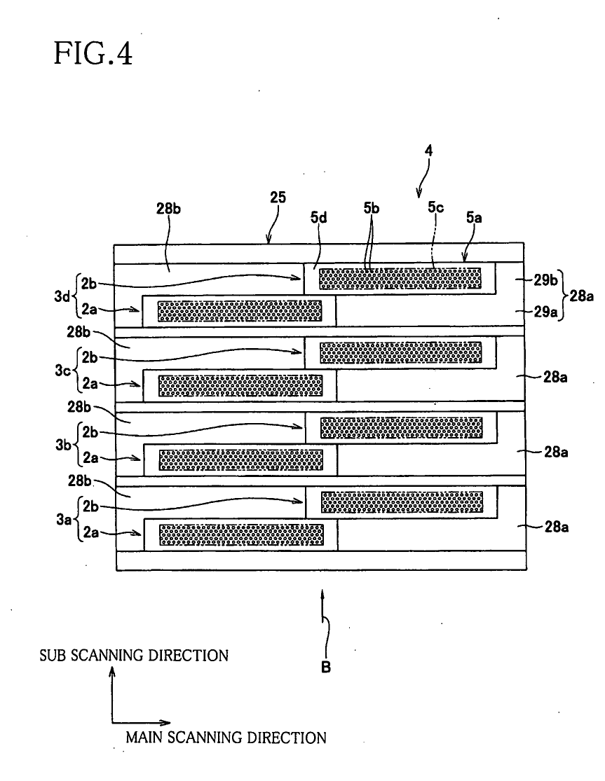

As shown in FIG. 4, in a bottom surface of each head body 5, namely, in an ink ejection surface 5a, there are formed a plurality of nozzles 5b each as an ejection opening which have a minute diameter and through which the ink is ejected. Each ink ejection surface 5a includes: an ink ejection region 5c as a liquid ejection region within which the plurality of nozzles 5b are disposed; and an outside region 5d which encloses the ink ejection region 5c.

As shown in FIG. 4, the eight ink-jet heads 2a, 2b are arranged such that two rows are formed in a zigzag fashion, each row extending in the sub scanning direction and including four of the eight ink ejection surfaces 5a, and such that the four ejection surfaces 5a in one of the two rows do not overlap the four ejections surfaces 5a in the other of the two rows as viewed in the main scanning direction, namely, such that the four ejection surfaces 5a in one of the two rows and the four ejections surfaces 5a in the other of the two rows are shifted from each other in the sub scanning direction. Each of the head pairs 3a-3d consists of two ink-jet heads 2a, 2b whose ink ejection surfaces 5a are adjacent to each other in the sub scanning direction and which belong to one and the other of the two rows.

The two ink-jet heads 2a, 2b belonging to each head pair 3a-3d are disposed such that the respective ink ejection surfaces 5a partially overlap each other as viewed in the sub scanning direction and such that a print region with respect to the sheet extends over the sheet throughout the main scanning direction, in other words, the respective ink ejection regions 5c of the two ink-jet heads 2a, 2b are contiguous to each other in the main scanning direction. More specifically, the two ink-jet heads 2a, 2b are disposed such that a distance between any two nozzles 5b adjacent to each other in the main scanning direction in one ink-jet head is made equal to a distance between one nozzle 5b located innermost (rightmost in FIG. 4) in the ink ejection surface 5a of the ink-jet head 2a belonging to the head pair 3a and one nozzle 5b located innermost (leftmost in FIG. 4) in the ink ejections surface 5a of the ink-jet head 2b belonging to the same head pair 3a. The two ink-jet heads 2a, 2b in the other head pairs 3b, 3c, 3d are similarly disposed. The color of the ink to be ejected from the two ink-jet heads 2a, 2b of each head pair varies from one head pair to another. In other words, the head pairs 3a-3d eject mutually different four colors of inks, i.e., magenta, yellow, cyan, and black, namely, the two ink-jet heads 2a, 2b in the same head pair eject the same color of ink.

As shown in FIG. 3, each of the filler plates 28a, 28b is fixed to the support frame 25 such that the corresponding longitudinally extended portion of the reservoir unit 16 is sandwiched between the filler plate 28a, 28b and the support frame 25, so that the bottom surface of the filler plate 28a, 28b is flush with the ink ejection surface 5a. As shown in FIG. 4, each filler plate 28a, 28b includes: an elongate portion 29a having a width as measured in the sub scanning direction which is equal to that of the ink ejection surface 5a and extending in the main scanning direction; and a protruding portion 29b that protrudes from an outer end section of the elongate portion 29a toward the sub scanning direction. Thus, each filler plate 28a, 28b has an L-shape in its plan view.

The four filler plates 28a correspond to the four ink-jet heads 2a of one of the two rows while the other four filler plates 28b correspond to the four ink-jet heads 2b of the other of the two rows. The four filler plates 28a corresponding to the four ink-jet heads 2a are disposed such the elongate portion 29a of each filler plate 28a overlap, as viewed in the main scanning direction, the ink ejection surface 5a of a corresponding one of the four ink-jet heads 2a in the left-side row in FIG. 4 and overlap, as viewed in the sub scanning direction, the ink ejection surfaces 5a of the respective four ink-jet heads 2b in the right-side row in FIG. 4. On the other hand, the four filler plates 28b corresponding to the four ink-jet heads 2b are disposed such the elongate portion 29a of each filler plate 28b overlap, as viewed in the main scanning direction, the ink ejection surface 5a of a corresponding one of the four ink-jet heads 2b in the right-side row in FIG. 4 and overlap, as viewed in the sub scanning direction, the ink ejection surfaces 5a of the respective four ink-jet heads 2a in the left-side row in FIG. 4. In other words, the elongate portion 29a of each filler plate 28a, 28b functions as a plate member which is disposed so as to overlap, as viewed in the main scanning direction (the first direction), a corresponding one of a part of the ink-jet heads 2a, 2b that belong to one of the two rows and so as to overlap, as viewed in the sub scanning direction (the second direction), the reset of the ink-jet heads 2a, 2b that belong to the other of the two rows.

As shown in FIGS. 2 and 3, the support frame 25 is supported by a pair of support-frame moving mechanisms 51 provided on the printer 1 so as to be movable in the vertical direction. The support-frame moving mechanisms 51 are disposed on opposite sides of the head unit 4 in the sub scanning direction. Each support-frame moving mechanism 51 includes a head motor 52 as a drive source for moving the support-frame 25 in the vertical direction, a pinion gear 53 fixed to the shaft of the head motor 52, a rack gear 54 meshing with the pinion gear 53, a guide 56 disposed such that the rack gear 54 is interposed between the guide 56 and the pinion gear 53.

The head motors 52 of the respective support-frame moving mechanisms 51 are fixed to respective main body frames 1a of the ink-jet printer 1. The main body frames 1a as a pair are disposed so as to face each other in the sub scanning direction. Each rack gear 54 extends in the vertical direction and is fixed at its lower end to a side surface of the support frame 25 facing the corresponding main body frame 1a. One side face of the rack gear 54 remote from the pinion gear 53 is held in slidable contact with the guide 56 that is fixed to the corresponding main body frame 1a.

When the pinion gears 53 are rotated in a forward or a reverse direction with the respective head motors 52 synchronously driven, the rack gears 54 are moved upward or downward. Along with the movement of the rack gears 54, the support frame 25 is moved upward or downward together with the head unit 4.

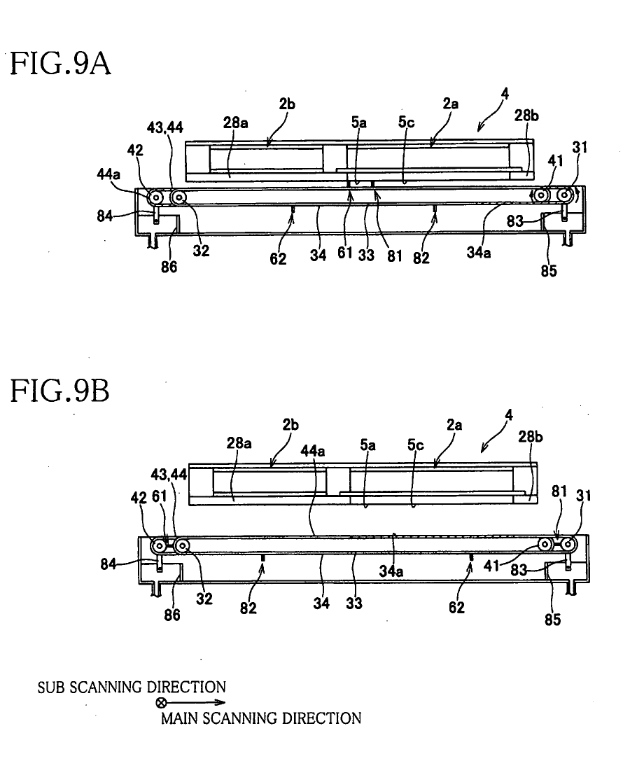

The eight ink-jet heads 2 (2a, 2b) are normally located at a print position (i.e., the position of the ink-jet heads 2a, 2b shown in FIG. 3) at which the respective ink ejection surfaces 5a are parallel with the sheet conveying surface 8a of the conveyor belt 8 and a prescribed clearance is formed between the ink ejection surfaces 5a and the sheet conveying surface 8a. In this structure, when the sheet conveyed by the conveyor belt 8 passes immediately below the head bodies 5 of the respective eight ink-jet heads 2 in order, a desired image is formed on the sheet. Upon maintenance of the ink-jet heads 2a, 2b, the support frame 25 is moved by the pair of support-frame moving mechanisms 51 in a direction indicated by an arrow C in FIG. 3, so that the support frame 25 is placed at a head maintenance position (FIG. 9B) whose height level is higher than the print position.

Next, there will be explained a maintenance unit 70 for performing a maintenance operation on the ink-jet heads 2a, 2b.

In the printer 1, the maintenance unit 70 is disposed on a left side of the head unit 4 as shown in FIGS. 2 and 3. The maintenance unit 70 includes a tray 71 that is configured to be horizontally movable. The tray 71 has a generally square, box-like shape opening upward.

The tray 71 is slidably supported by a pair of guide shafts 96a, 96b (FIG. 2) extending in the main scanning direction. Two bearing members 97a, 97b are provided on respective side walls 71a, 71b of the tray 71 which are opposed to each other in the sub scanning direction. Each of the guide shafts 96a, 96b are fixed at its opposite ends to a rightmost main body frame 1b in FIG. 2 and a leftmost main body frame 1d in FIG. 2 that are opposed to each other in the main scanning direction. The two guide shafts 96a, 96b are disposed parallel to each other between those main body frames 1b, 1d.

There will be next explained a horizontally moving mechanism 91 as a maintenance-unit moving mechanism for moving the tray 71 in the horizontal direction indicated by an arrow D in FIG. 3 along the guide shafts 96a, 96b. As shown in FIG. 2, the horizontally moving mechanism 91 includes a tray motor 92, a motor pulley 93, an idle pulley 94, a timing belt 95, and the guide shafts 96a, 96b.

The tray motor 92 is fixed to an attachment part 1c formed at one end of the rightmost main body frame 1b that extends parallel to the sub scanning direction. The motor pulley 93 is connected to the tray motor 92 and is rotated when the tray motor 92 is driven. The idle pulley 94 is rotatably supported by the leftmost main body frame 1d. The timing belt 95 is disposed parallel to the guide shaft 96a and is wound around the motor pulley 93 and the idle pulley 94 so as to be stretched therebetween. The bearing member 97a provided on the tray 71 is connected to the timing belt 95.

In the arrangement, when the tray motor 92 is driven, the motor pulley 93 is rotated in a forward or a reverse direction and the timing belt 95 thereby runs. As the timing belt 95 runs, the tray 71 connected to the timing belt 95 via the bearing member 97a is moved in the horizontal direction.

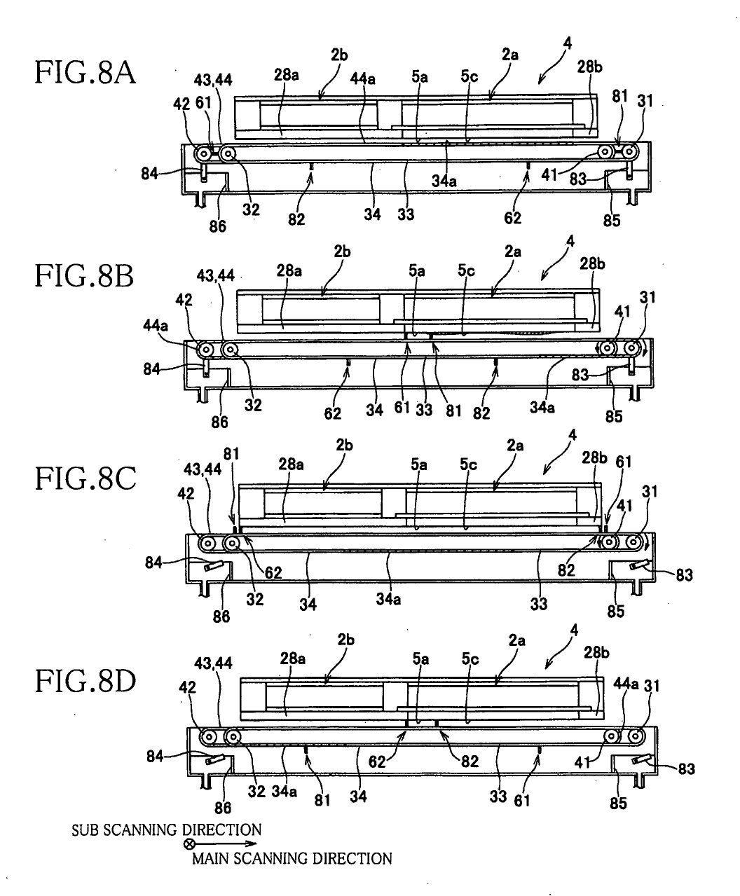

When the maintenance operation is not performed on the ink-jet heads 2a, 2b, the maintenance unit 70 is located at a retracted position shown in FIGS. 2 and 3 at which the maintenance unit 70 does not face the ink-jet heads 2a, 2b. When the maintenance operation is performed, namely, when the maintenance unit 70 is moved from the retracted position to a maintenance position (FIG. 8A) at which the maintenance unit 70 faces the ink-jet heads 2a, 2b, the support frame 25 is moved, in advance, upward (in the direction indicated by the arrow C in FIG. 3) to the head maintenance position, so that a space is formed between the eight ink ejection surfaces 5a and the sheet conveying surface 8a of the conveyor belt 8 for accommodating the maintenance unit 70. Thereafter, the maintenance unit 70 is horizontally moved in the direction indicated by the arrow D in FIG. 3.

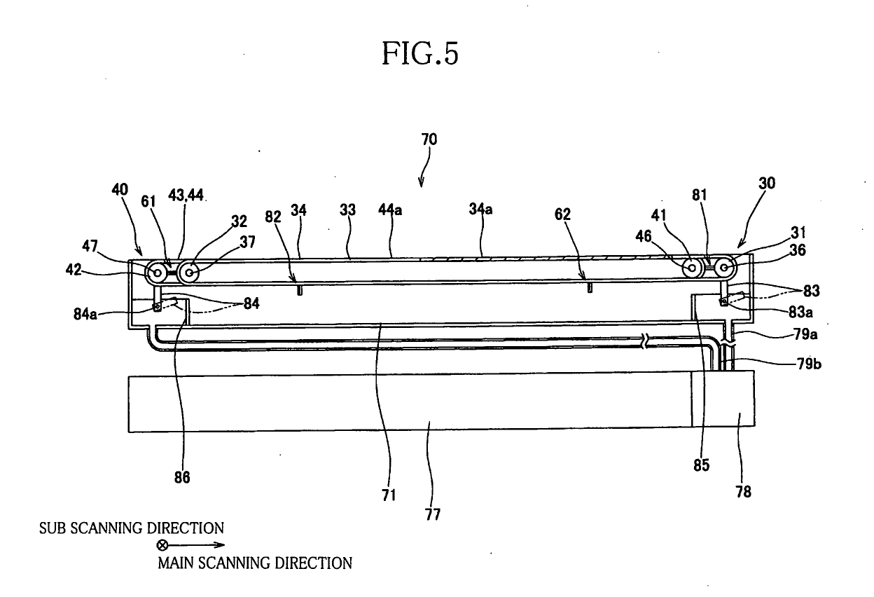

As shown in FIG. 5, right below the maintenance unit 70, there are disposed a waste-ink storing portion 77 and a pump 78 (as a discharging device) connected to the waste-ink storing portion 77. To the pump 78, there are connected flexible tubes 79a, 79b communicating respectively with ink storing portions 85, 86 explained below. In the arrangement, when the pump 78 is driven, the ink stored in the ink storing portions 85, 86 flows to the pump 78 through the respective tubes 79a, 79b and is finally discharged from the pump 78 into the waste-ink storing portion 77.

As shown in FIG. 2, there are disposed, in the tray 71, four maintenance devices 30 for performing maintenance on the four ink jet heads 2a and the four filler plates 28a (i.e., the elongate portions 29a of the filler plates 28a in a strict sense) and four maintenance devices 40 for performing maintenance on the four ink jet heads 2b and the four filler plates 28b (i.e., the elongate portions 29a of the filler plates 28b in a strict sense). The four maintenance devices 40 and the four maintenance devices 30 are alternately disposed in the sub scanning direction.

As shown in FIGS. 2 and 5, each maintenance device 30 includes: a pair of rollers 31, 32; a ribbon-like belt 33 as a sheet member stretched between the pair of rollers 31, 32; a wiping member 61 for wiping the corresponding ink ejection surface 5a; and a wiping member 62 for wiping the corresponding filler plate 28a. The wiping members 61, 62 protrude from an outer surface 34 of the belt 33.

Each belt 33 is formed of a flexible material and has a width as measured in the sub scanning direction which is substantially equal to that of the ink ejection surface 5a. The outer surface 34 of the belt 33 has an ink receiving section 34a for receiving the ink ejected from the nozzles 5b of the corresponding ink-jet head 2a. The ink receiving section 34a has a size substantially equal to the ink ejection surface 5a. It is noted that each of hatched areas of the respective belts 33 in FIG. 2 corresponds to the ink receiving section 34a and that a hatched area of the outer surface 34 of the belt 33 in FIG. 5 corresponds to the ink receiving section 34a.

Each roller 31 is fixed to a shaft 36 which extends in the sub scanning direction and which is rotatably supported by the two side walls 71a, 71b of the tray 71. Each roller 32 is rotatably supported by a shaft 37 which extends in the sub scanning direction and which is fixed to the two side walls 71a, 71b of the tray 71. That is, the roller 32 is a driven roller configured to rotate when the belt 33 runs. A drive motor 39 for giving a rotational force to the shaft 36 is fixed to the side wall 71a of the tray 70. Further, a gear 38 is fixed at the vicinity of one end of the shaft 36, i.e., an upper end of the shaft 36 as seen in FIG. 2.

Each maintenance device 40 includes: a pair of rollers 41, 42; a ribbon-like belt 43 as the sheet member stretched between the pair of rollers 41, 42; a wiping member 81 for wiping the corresponding ink ejection surface 5a; and a wiping member 82 for wiping the corresponding filler plate 28b. The wiping members 81, 82 protrude from an outer surface 44 of the belt 43.

Like the belt 33, each belt 43 is formed of the flexible material and has a width as measured in the sub scanning direction which is substantially equal to that of the ink ejection surface 5a. The outer surface 44 of the belt 43 has an ink receiving section 44a for receiving the ink ejected from the nozzles 5b of the corresponding ink-jet head 2b. The ink receiving section 44a has a size substantially equal to the ink ejection surface 5a. It is noted that each of hatched areas of the respective belts 43 in FIG. 2 corresponds to the ink receiving section 44a.

Each roller 41 is fixed to a shaft 46 disposed similarly to the shaft 36 and adjacent to the same 36. Each roller 42 is rotatably supported by a shaft 47 disposed similarly to the shaft 37 and adjacent to the same 37. That is, like the roller 32, the roller 42 is a driven roller configured to rotate when the belt 43 runs. A gear 48 meshing with the gear 38 is fixed at the vicinity of one end of the shaft 46, i.e., an upper end of the shaft 46 as seen in FIG. 2, for transmitting the rotational force of the shaft 36 to the shaft 46.

In the arrangement described above, when the shaft 36 rotates in a prescribed direction by the drive motor 39 being driven, the four rollers 31 rotate and the four belts 33 run. In this instance, the shaft 46 rotates in a direction opposite to the above-indicated prescribed direction owing to the rotational force transmitted thereto via the two gears 38, 48, and the four belts 43 run in a direction opposite to the direction in which the belts 33 run. Thus, a belt moving mechanism as a sheet-member moving mechanism for moving the belts 33, 43 is constituted simply by including the drive motor 39, the shafts 36, 37, 46, 47, the rollers 31 (each as a drive roller), and the rollers 41. As the belts 33 run, the wiping members 61, 62 are moved in a direction of the movement of the belts 33, whereby the bottom surfaces of the ink ejection surfaces 5a of the ink-jet heads 2a and the bottom surfaces of the filler plates 28a (i.e., the bottom surfaces of the elongate portions 29a of the filler plates 28a in a strict sense) are wiped. As the belts 43 run, the wiping members 81, 82 are moved in a direction of the movement of the belts 43, whereby the bottom surfaces of the ink ejection surfaces 5a of the ink-jet heads 2b and the bottom surfaces of the filler plates 28b (i.e., the bottom surfaces of the elongate portions 29a of the filler plates 28b in a strict sense) are wiped. When the shaft 36 rotates in a direction opposite to the above-indicated prescribed direction by the drive motor 39 being driven, the belts 33 reversely run, whereby the wiping members 61, 62 are reversely moved to wipe the bottom surfaces of the ink ejection surfaces 5a and the bottom surfaces of the filler plates 28a. Similarly, the belts 43 reversely run, whereby the wiping members 81, 82 are reversely moved to wipe the bottom surfaces of the ink ejection surfaces 5a and the bottom surfaces of the filler plates 28b. It is noted that each of the wiping members 62, 82 has plate wipers for wiping the filler plates 28a, 28b.

The belts 33, 43 are normally disposed at respective stationary positions where the respective ink receiving sections 34a, 44a face the corresponding ink ejection surfaces 5a when the maintenance unit 70 is moved from the retracted position to the maintenance position and where the ink receiving section 34a, 44a of each belt 34, 44 is located at an upper one of two straight portions of each belt 34, 44 that extend in the main scanning direction. In other words, each belt 34, 43 is stopped at its stationary position such that the ink receiving section 34a, 44a is disposed at a receive position where the ink receiving section 34a, 44a can receive the ink ejected from the nozzles 5b. After the maintenance unit 70 has been moved to the maintenance position and the ink is ejected to the ink receiving sections 34a, 44a, the belts 33, 43 run, so that the ink receiving sections 34a, 44a are moved by the belt moving mechanism from the receive position to a non-receive position where the ink receiving sections 34a, 44a cannot face the ink ejection surfaces 5a.

When each ink receiving section 34a is located at the receive position, the wiping device 61 is located at a section of the belt 33 intersecting the ink receiving section 34a, i.e., at a section of the belt 33 wound around the roller 32. Similarly, when each ink receiving section 44a is located at the receive position, the wiping device 81 is located at a section of the belt 43 intersecting the ink receiving section 44a, i.e., at a section of the belt 43 wound around the roller 41. When the maintenance unit 70 is located at the maintenance position and the ink receiving section 34a is located at the receive position, the wiping member 62 is located at a section of the belt 33 that cooperates with the corresponding ink ejection surface 5a to interpose the ink receiving section 34a therebetween, namely, at a lower one of the two straight portions of the belt 33, as shown in FIG. 5. Similarly, when the maintenance unit 70 is located at the maintenance position and the ink receiving section 44a is located at the receive position, the wiping member 82 is located at a section of the belt 43 that cooperates with the corresponding ink ejection surface 5a to interpose the ink receiving section 44a therebetween, namely, at a lower one of the two straight portions of the belt 43, as shown in FIG. 5.

Since the wiping devices 61, 62, 81, 82 are thus disposed, there exist no components that protrude upward from outer surfaces of the upper straight portions of the respective belts 33, 43 when the maintenance unit 70 is placed at the maintenance position. Accordingly, it is possible to reduce a distance by which the ink ejection surfaces 5a and the ink receiving sections 34a, 44a are spaced apart from each other. Therefore, the arrangement makes it possible to prevent the mist of the ink ejected from the nozzles 5b to the ink receiving sections 34a, 44a from drifting in the air.

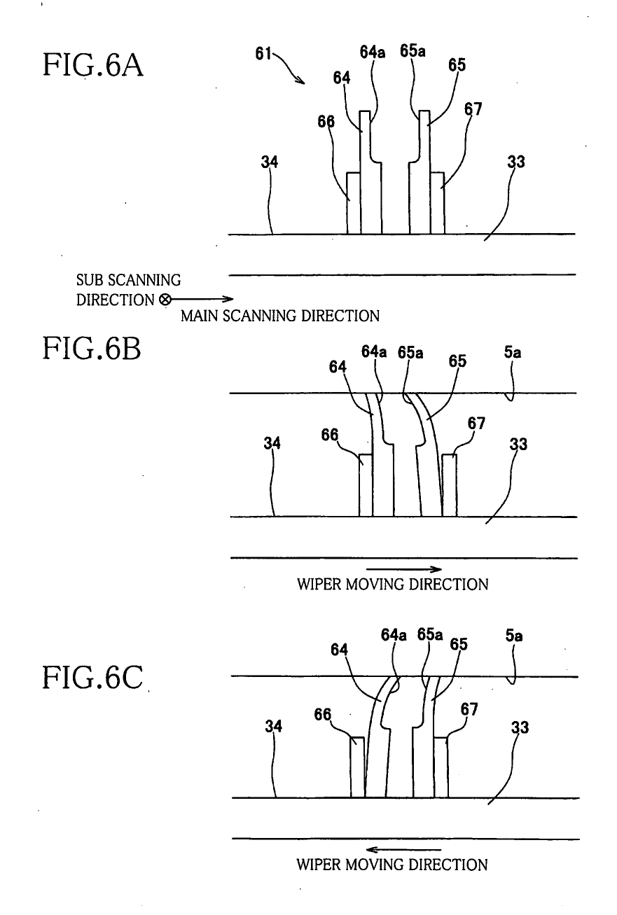

Referring next to FIGS. 6A-6C, the wiping members 61, 62, 81, 82 will be explained. Because the wiping members 61, 62, 81, 82 are identical with each other in construction, only the wiping member 61 will be explained here and an explanation of the other wiping members 62, 81, 82 will not be given.

As shown in FIG. 6A, each wiping member 61 includes two wipers 64, 65 made of an elastic member such as rubber, and two back-up members 66, 67 disposed so as to sandwich the two wipers 64, 65 therebetween. The wipers 64, 65 protrude from the outer surface 34 of the belt 33 and have a width as measured in the sub scanning direction which is slightly larger than that of the ink ejection region 5c. Each of the wipers 64, 65 has an inward recess 64a, 65a formed between its vertically intermediate portion and its leading end.

When the belt 33 moves in the rightward direction in FIG. 6B to wipe the ink ejection surface 5a, the wiper 65 deflects more largely than the wiper 64 that is disposed upstream of the wiper 65 in the wiper moving direction indicated by an arrow in FIG. 6B, owing to the inward recess 65a of the wiper 65. Similarly, when the belt 33 moves in the leftward direction in FIG. 6C to wipe the ink ejection surface 5a, the wiper 64 deflects more largely than the wiper 65 that is disposed upstream of the wiper 64 in the wiper moving direction indicated by an arrow in FIG. 6C, owing to the inward recess 64a of the wiper 64. According to the arrangement, the ink attached to the ink ejection surface 5a can be removed to a certain extent by one of the two wipers 64, 65 that is located downstream of the other of the two wipers 64, 65 in the wiper moving direction while preventing the ink ejection surface 5a from being worn, and the ink that still remains on the ink ejections surface 5a can be surely removed by the other of the two wipers 64, 65 that is located upstream of the above-indicated one of the two wipers 64, 65.

The two back-up members 66, 67 extend from the outer surface 34 of the belt 33 and have a width as measured in the sub scanning direction which is substantially equal to that of the wipers 64, 65. The back-up member 66 is disposed adjacent to the wiper 64 while the back-up member 67 is disposed adjacent to the wiper 65.

More specifically, when the belt 33 moves in the rightward direction shown in FIG. 6B, the back-up member 66 is located upstream of the wiper 64 that is located more upstream than the wiper 65 in the wiper moving direction while the back-up member 67 is located downstream of the wiper 65 that is located more downstream than the wiper 64. Because the two back-up members 66, 67 are thus disposed, one of the two wipers located more downstream than the other of the two wipers in the wiper moving direction is likely to largely deflect. Accordingly, the arrangement further ensures the above-indicated effect owing to the difference in the deflection amount between the two wipers 64, 65 upon wiping of the ink ejection surface 5a.

In the present embodiment, the wipers 64, 65 are constructed such that one of the two wipers that is located downstream of the other of the two wipers in the wiper moving direction can more largely deflect than the other of the two wipers that is located upstream of the above-indicated one of the two wipers, owing to the shape of the wipers 64, 65, namely, owing to the existence of the inward recesses 64a, 65a. Accordingly, the back-up members 66, 67 may be eliminated. Further, in a case where the back-up members 66, 67 are provided, the provision of the back-up members 66, 67 can ensure an effect similar to that owing to the cross sectional shape of each wiper 64, 65. Accordingly, in that case, each wiper 64, 65 may not have the inward recess 64a, 65a.

As shown in FIG. 5, there are provided, in the tray 71, two blades 83, 84 each as a removing member for removing the ink attached to the ink receiving section 34a of the belt 33 and the ink attached to the ink receiving section 44a of the belt 43, respectively, and the two ink storing portions 85, 86 for storing the ink removed by the blade 83 and the ink removed by the blade 84, respectively. The blades 83, 84 and the ink storing portions 85, 86 constitute a cleaning device.

Each of the blades 83, 84 is made of an elastic member such as rubber. The blades 83, 84 are respectively fixed to shafts 83a, 84a which extend in the sub scanning direction and which are rotatably supported by the side walls 71a, 71b of the tray 71. The blade 83 extends so as to bridge the four belts 33 in the sub scanning direction and is configured to be capable of contacting the outer surfaces 34 of the respective four belts 33. The blade 84 extends so as to bridge the four belts 43 in the sub scanning direction and is configured to be capable of contacting the outer surfaces 44 of the respective four belts 43. As shown in FIG. 2, two swing motors 87, 88 respectively for swinging the shafts 83a, 84a are fixed to the side wall 71b of the tray 71. The swing motor 87 is disposed at a position where the swing motor 87 is opposed to the shaft 83a with the side wall 71b interposed therebetween while the swing motor 88 is disposed at a position where the swing motor 88 is opposed to the shaft 84a with the side wall 71b interposed therebetween.

In the structure described above, when the shafts 83a, 84a rotate in a prescribed direction by the respective swing motors 87, 88, the blades 83, 84 indicated in a solid line in FIG. 5 swing from respective contact positions at which the blades 83, 84 are in contact with the respective outer surfaces 34, 44 of the belts 33, 43, to respective standby positions where the blades 83, 84 are not in contact with the respective outer surfaces 34, 44. The blades 83, 84 in the standby positions are indicated in a two-dot chain line in FIG. 5. On the other hand, when the shafts 83a, 84a rotate in a direction opposite to the above-indicated prescribed direction, each of the blades 83, 84 swings from the standby position to the contact position. The belts 33, 43 run when the blades 83, 84 are located at the respective contact positions, whereby the ink attached to the ink receiving sections 34a, 44a is removed by the respective blades 83, 84. The ink removed by the blade 83 is stored in the ink storing portion 85 while the ink removed by the blade 84 is stored in the ink storing portion 86.

Referring next to the block diagram of FIG. 7, a control system of the ink-jet printer 1 will be explained. The ink-jet printer 1 has a controller 100 for controlling operations of the printer 1. The controller 100 includes a CPU (Central Processing Unit) as a processor, a ROM (Read Only Memory) in which are stored control programs executed by the CPU and data to be utilized in the control programs, and a RAM (Random Access Memory) for temporarily storing the data upon execution of the programs. The CPU, the ROM, and the RAM function as a print control portion 101, a conveyance control portion 102, a head-movement control portion 103, a pump control portion 104, a tray-movement control portion 105, a belt-movement control portion 106, and a blade-movement control portion 107.

The print control portion 101 is configured to control the ink-jet heads 2a, 2b to eject the ink therefrom based on print data transmitted from an external device such as a PC (personal computer) 120, when the controller 100 receives the print data from the PC 120, for instance.

The conveyance control portion 102 is configured to control the pick-up motor 130 and the feed motor 140 when the controller 100 receives the print data form the external device such as the PC 120. More specifically, the conveyance control portion 102 controls the pick-up motor 130 such that the pick-up roller 22 rotates so as to feed an uppermost one of the sheets accommodated in the sheet tray 21 onto the conveyor belt 8 and controls the feed motor 140 such that the conveyor belt 8 runs so as to convey the sheet thereon in the sheet-conveyance direction B.

The head-movement control portion 103 is configured to control the head motors 52, in accordance with the maintenance operation, to move the head unit 4 upward or downward, when the controller 100 receives a maintenance signal from the external device such as the PC 120.

The pump control portion 104 is configured to control ink supply pumps 150 such that the ink is forcibly supplied from respective ink tanks (not shown) to the respective ink-jet heads 2a, 2b and is finally ejected from the nozzles 5b, when the controller 100 receives the maintenance signal from the external device such as the PC 120. The pump control portion 104 is configured also to control the pump 78 in accordance with the maintenance operation, such that the ink stored in the ink storing portions 85, 86 is discharged into the waste-ink storing portion 77.

The tray-movement control portion 105 as a maintenance-unit controller is configured to control the tray motor 92, in accordance with the maintenance operation, to move the maintenance unit 70 between the retracted position and the maintenance position.

The belt-movement control portion 106 as a sheet-member-movement controller is configured to control the drive motor 39 to move each of the belts 33, 43, such that each of the ink receiving sections 34a, 44a is moved from the receive position to the non-receive position, when the maintenance unit 70 is located at the maintenance position. In this instance, the wiping members 61, 62, 81, 82 are also moved, whereby the ink ejection surfaces 5a and the bottom surfaces of the filler plates 28a, 28b are wiped.

The blade-movement control portion 107 is configured to control the swing motors 87, 88, in accordance with the maintenance operation, to swing each of the blades 83, 84 between the contact position and the standby position.

Referring next to FIGS. 8A-8D and 9A-9B, the maintenance operation performed by the maintenance unit 70 will be explained. FIGS. 8A-8D are views chronologically showing a purging operation performed on ink-jet heads 2a, 2b and a first wiping operation in which the ink ejection surfaces 5a and the bottom surfaces of the filler plates 28a, 28b are wiped. FIGS. 9A-9B are views chronologically showing a second wiping operation in which the ink ejection surfaces 5a and the bottom surfaces of the filler plates 28a, 28b are again wiped after the first wiping operation.

When the ink-jet heads 2a, 2b suffer from ink ejection failure, for instance, the maintenance signal is sent from the PC 120 to the controller 100 by a user's operation. When the controller 100 receives the maintenance signal, the head-movement control portion 103 controls the head motors 52 to move the head unit 4 from the print position up to the head maintenance position.

Subsequently, the tray-movement control portion 105 drives the tray motor 92 such that the maintenance unit 70 is moved from the retracted position to the maintenance position, as shown in FIG. 8A. Since the belts 33, 43 are kept at the respective stationary positions with the ink receiving sections 34a, 44a thereof located at the respective receive positions as explained above, the ink receiving sections 34a, 44a are opposed to the corresponding ink ejection surfaces 5a (ink ejection regions 5c) of the respective ink-jet heads 2a, 2b when the maintenance unit 70 reaches the maintenance position. On this occasion, the blades 83, 84 are located at the respective contact positions. After the maintenance unit 70 has been placed at the maintenance position, the head-movement control portion 103 controls the head motors 52 to move the head unit 4 downward such that the ink ejection surfaces 5a and the ink receiving sections 34a, 44a approach relative to each other to an extent not to contact each other, as shown in FIG. 8A. In this instance, since the wiping members 61, 81 are located at the respective sections of the belts 33, 43 wound around the respective rollers 32, 41 and intersecting the ink receiving sections 33a, 44a and the wiping members 62, 82 are located at the respective lower straight portions of the belts 33, 43 as explained above, the ink ejections surfaces 5a can be disposed more closely to the belts 33, 43, as compared with an instance where the ink ejections surfaces 5a are wiped by the wiping members 61, 81. Accordingly, when the ink is ejected to the ink receiving regions 34a, 44a as described below, the ink mist is less likely to drift in the air.

Thereafter, the pump control portion 104 drives the ink supply pumps 150 for a prescribed time, such that the ink is ejected from the ink-jet heads 2a, 2b to the corresponding ink receiving sections 34a, 44a for the purging operation. After the ink ejection from the ink-jet heads 2a, 2b has been completed, the head-movement control portion 103 drives the head motors 52 to move the head unit 4 up to the maintenance position.

Subsequently, the belt-movement control portion 106 drives the drive motor 39, such that the wiping members 61, 81 are moved to respective positions where the wiping members 61, 81 are opposed to respective inner ends of the corresponding ink ejection surfaces 5a, namely, a position where each wiping member 61 is opposed to the left end of the corresponding ink-jet head 2a and a position where each wiping member 81 is opposed to the right end of the corresponding ink-jet head 2b, as shown in FIG. 8B. On this occasion, each roller 31 rotates clockwise in FIG. 8B, whereby the corresponding wiping member 61 is moved from the left to the right. Further, each roller 41 rotates counterclockwise in FIG. 8B, whereby the corresponding wiping member 81 is moved from the right to the left. That is, each wiping member 61 and each wiping member 81 are moved in mutually opposite directions. On this occasion, each ink receiving section 34a comes into contact with the blade 83 and each ink receiving section 44a comes into contact with the blade 84, so that the ink adhering to the ink receiving sections 34a, 44 is removed by the respective blades 83, 84. Then the head-movement control portion 103 controls the head motors 52 to move the head unit 4 down to a position at which the wipers 64, 65 of the wiping members 61, 81 contact the corresponding ink ejection surfaces 5a, as shown in FIG. 8B. On this occasion, the ink ejection surfaces 5a are located at a height level at which a distance between the ink ejection surfaces 5a and the outer surfaces 34, 44 of the respective belts 33, 43 is larger than that in an instance where the purging operation is performed.

Subsequently, the belt-movement control portion 106 drives the drive motor 39, such that the wiping members 61 move to the right and the wiping members 81 move to the left, as shown in FIG. 8C, for wiping the ink off the corresponding ink ejection regions 5c of the ink-jet heads 2a, 2b. Thus, even when the eight ink-jet heads 2a, 2b are arranged in the two rows in the zigzag fashion as described above, all of the ink ejection surfaces 5a can be simultaneously wiped, thereby reducing a time required for wiping the ink ejection surfaces 5a.

After the wiping members 61, 81 reach respective positions where the wiping members 61, 81 do not face the corresponding ink ejection surfaces 5a, the blade-movement control portion 107 drives the swing motor 87, 88 such that the blades 83, 84 are moved from the respective contact positions to the respective standby positions. On this occasion, the ink receiving sections 34a, 44a is already located at the respective non-receive positions after having contacted the respective blades 83, 84, as shown in FIG. 8C, and the ink attached to the ink receiving sections 34a, 44a has been already removed therefrom by the blades 83, 84. Further, the wiping members 61, 81 are prevented from contacting the blades 83, 84 since the blades 83, 84 have been moved to the standby positions.

On this occasion, the pump control portion 104 drives the pump 78 for a prescribed time, so that the ink having been removed from the ink receiving sections 34a, 44a by the blades 83, 84 and stored in the ink storing portions 85, 86 is discharged into the waste-ink storing portion 77. Further, the wipers of the wiping members 62, 82 come into contact with outer ends of the bottom surfaces of the corresponding filler plates 28a, 28b, so that the wiping members 62, 82 begin to wipe the corresponding filler plates 28a, 28b.

When the wiping members 62, 82 reach respective inner ends of the corresponding filler plates 28a, 28b, namely, when each wiping member 62 reaches the right end of the corresponding filler plate 28a and when each wiping member 82 reaches the left end of the corresponding filler plate 28b as shown in FIG. 8D, the belt-movement control portion 106 drives the drive motor 39 to stop the belts 33, 43 from running. Thus, the bottom surfaces of the filler plates 28a 28b are wiped by the corresponding wipers (the wiping members 62, 82) for wiping the filler plates 28a, 28b, thereby preventing the ink mist adhering to the bottom surfaces of the filler plates 28a, 28b from abruptly dropping therefrom. Further, since the movement of the wiping members 62, 82 is stopped when each wiping member 62 reaches the inner end of the bottom surface of the corresponding filler plate 28a and each wiping member 82 reaches the inner end of the bottom surface of the corresponding filler plate 28b, foreign matters wiped off by the wipers of the wiping members 62, 82 are prevented from adhering to the ink ejection surfaces 5a. Thus, the first wiping operation in which the ink ejection surfaces 5a and the filler plates 28a, 28b are wiped is completed.

Thereafter, the belt-movement control portion 106 drives the drive motor 39, such that the wiping members 62, 82 again wipe the bottom surfaces of the corresponding filler plates 28a, 28b and such that the wiping members 61, 81 again wipe the corresponding ink ejection surfaces 5a, as shown in FIG. 9A. More specifically, each roller 31 rotates counterclockwise as shown in FIG. 9A, so that each wiping member 62 is moved from the right to the left while contacting the corresponding filler plate 28a and each wiping member 61 is moved from the right to the left while contacting the corresponding ink ejection surface 5a. Similarly, each roller 41 rotates clockwise as shown in FIG. 9A, so that each wiping member 82 is moved from the left to the right while contacting the corresponding filler plate 28b and each wiping member 81 is moved from the left to the right while contacting the corresponding ink ejection surface 5a.

When the wiping members 61, 81 begin to again wipe the ink ejection surfaces 5a and when the wiping members 61, 81 have reached respective positions where the wiping members 61, 81 are opposed to the outer ends of the corresponding ink ejection surfaces 5a, the blade-movement control portion 107 drives the swing motors 87, 88 to move the blades 83, 84 to the respective contact positions as shown in FIG. 9A. On this occasion, the ink receiving sections 34a, 44a have not yet contacted the blades 83, 84 located at the contact positions. As the belts 33, 43 keep running, the ink receiving sections 34a, 44a come into contact with the respective blades 83, 84, whereby the ink attached to the ink receiving sections 34a, 44a can be again removed. Accordingly, the ink attached to the ink receiving sections 34a, 44a can be almost removed therefrom.

When the wiping members 61, 81 reach the respective positions where the wiping members 61, 81 are opposed to the inner ends of the corresponding ink ejection surfaces 5a, the belt-movement control portion 106 controls the drive motor 39 to stop the belts 33, 43 from running. Then the head-movement control portion 106 drives the head motors 52 to move the head unit 4 up to the head maintenance position.

Subsequently, the belt-movement control portion 106 drives the motor 39, such that the ink receiving sections 34a, 44a are located at the respective receive positions and the wiping members 61, 81 are located at the respective sections of the belts 33, 43 wound around the respective rollers 32, 41 and intersecting the ink receiving sections 33a, 44a. Thus, the second wiping operation is completed in which the ink receiving sections 34a, 44a are moved from the respective non-receive positions back to the respective receive positions after completion of the first wiping operation. According to the arrangement, the ink ejection surfaces 5a and the bottom surfaces of the filler plates 28a, 28b can be wiped twice by the wiping members 61, 62, 81, 82, so that the foreign matters such as the ink adhering to those surfaces can be removed with higher reliability.

Subsequently, the tray-movement control portion 105 drives the tray motor 92 to move the maintenance unit 70 from the maintenance position to the retracted position. Then the head-movement control portion 103 drives the head motors 52 to move the head unit 4 downward from the head maintenance position to the print position. Thus, the maintenance operation is completed.

In the ink-jet printer 1 according to the first embodiment, the ink receiving sections 34a, 44a are not covered with the respective belts 33, 43 per se even when the belts 33, 43 are moved from the receive positions to the non-receive positions after the ink receiving sections 33a, 43a at the receive positions have received the ejected ink. Accordingly, the ink attached to the ink receiving sections 34a, 44a is prevented from attaching to the inner surfaces of other sections of the belts 34, 43 except the ink receiving sections 33a, 44a, thereby obviating operation failure of the belts 33, 43.

Further, each of the wiping members 61, 62 provided on each belt 33 and each of the wiping members 81, 82 provided on each belt 43 has the two wipers. Accordingly, even when each ink ejection surface 5a is wiped only once, the ink adhering to the ink ejection surface 5a can be efficiently removed. Moreover, when each ink ejection surface 5a is wiped twice, the ink can be removed more efficiently from the ink ejection surface 5a.

The belts 33, 43 are disposed within the tray 71. Accordingly, even when the ink flows down from the ink receiving sections 34a, 44a, the ink is received in the tray 71, so that the inside of the ink-jet printer 1 is less likely to be stained with the ink.

In the tray 71, the cleaning device constituted by the blades 83, 84 and the ink storing portions 85, 86 is provided. Accordingly, the ink receiving sections 34a, 44a can be cleaned by the cleaning device, so that the ink received by the ink receiving sections 34a, 44a is less likely to be stick thereto.

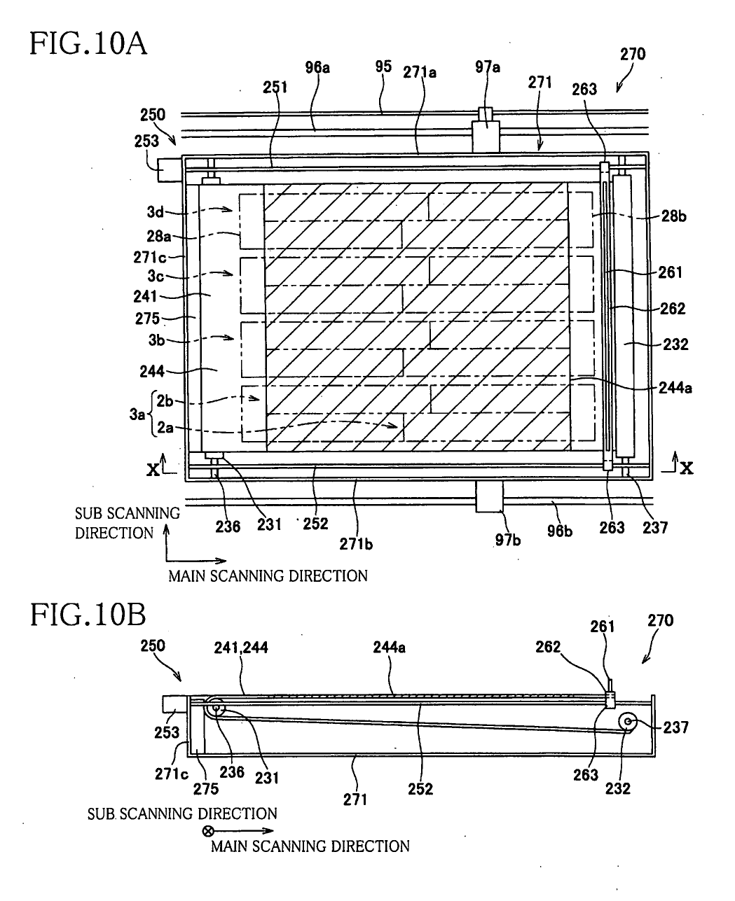

Referring next to FIGS. 10-12, there will be explained an ink-jet printer according to a second embodiment of the invention. The ink-jet printer according to the second embodiment has a maintenance unit 270 which is slightly different in construction from the maintenance unit 70 of the ink-jet printer according to the first embodiment. FIG. 10A is a plan view of the maintenance unit 270 and FIG. 10B is a cross-sectional view taken along line X-X of FIG. 10A. A hatched area in FIGS. 10A and 10B show an ink receiving section 244a formed on a ribbon-like sheet 241 explained below. Two-dot chain line in FIG. 10A shows an outline of each of the ink-jet heads 2a, 2b and an outline of each of the filler plates 28a, 28b when the maintenance unit 270 is located at its maintenance position. In the second embodiment, the same reference numerals as used in the illustrated first embodiment are used to identify the corresponding components, and a detailed explanation thereof is dispensed with.

As shown in FIGS. 10A and 10B, the maintenance unit 270 has a tray 271 similar to the tray 71 of the first embodiment. Like the tray 71, the tray 271 is configured to be horizontally moved between the retracted position and the maintenance position.

In the tray 271, there are provided: a pair of rollers 231, 232; the sheet 241 which is fixed at its one end to the roller 232 and a part of which is wound around the roller 231; a wiper 261 formed on an outer surface 244 of the sheet 241 so as to protrude therefrom; and a moving mechanism (as a sheet-member moving mechanism) 250 for moving the wiper 261 and the sheet 241. Among components that constitute the moving mechanism 250, only a drive motor 253 is disposed outside the tray 271.

The sheet 241 is formed of a flexible material and has a width as measured in the sub scanning direction slightly larger than the eight ink ejection surfaces 5a as a whole. The ink receiving section 244a is provided on the outer surface 244 of the sheet 241 for receiving the ink ejected from the eight ink-jet heads 2a, 2b. The ink receiving section 244a has a size larger than the eight ink ejection surfaces 5a as a whole.

The roller 231 is rotatably supported by a shaft 236 which extends in the sub scanning direction and which is fixed at opposite ends thereof to two side walls 271a, 271b of the tray 271 that are opposed to each other in the sub scanning direction. That is, the roller 231 is a driven roller configured to rotate in accordance with the movement of the sheet 241. The roller 232 is fixed to a shaft 237 which extends in the sub scanning direction and which is rotatably supported by the two side walls 271a, 271b of the tray 271. The shaft 237 is constantly given a rotational force in the counterclockwise direction in FIG. 10B by a rotation mechanism not shown, whereby the sheet 241 to be sagged when the sheet 241 and the wiper 261 move can be automatically rolled or wound around the roller 232.

The wiper 261 is made of an elastic member such as rubber and extends in the sub scanning direction with a dimension as measured in the sub scanning direction substantially equal to the width of the sheet 241. The wiper 261 is formed on a support member 262 fixed to the other end of the sheet 241, so as to extend upright from the same 262. The support member 262 has, at its opposite ends in the sub scanning direction, projecting portions 263 projecting downward. The projecting portions 263 are formed with respective through-holes into which round guide shafts 251, 252 described below are respectively inserted.

The moving mechanism 250 includes the guide shafts 251, 252 extending in the main scanning direction and the drive motor 253 configured to rotate the guide shaft 251 about its rotation axis. The entire outer circumferential surface of the guide shaft 251 is formed with an external thread that is screwed with an internal thread formed on the inner circumferential surface of the projecting portion 263 that gives the through-hole into which the guide shaft 251 is inserted.

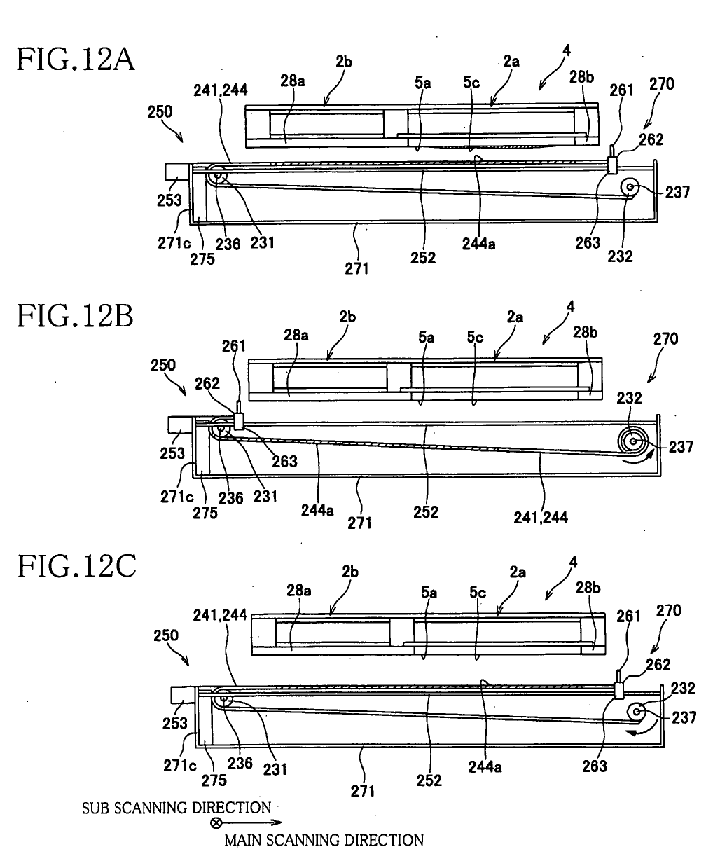

In the structure described above, when the guide shaft 251 rotates in a prescribed direction by the drive motor 253, the support member 262 is horizontally moved from the right to the left in FIGS. 10A and 10B along the guide shafts 251, 252 and the wiper 261 and the sheet 241 are moved in accordance with the movement of the support member 262. More specifically, at the maintenance position of the maintenance unit 270, the ink receiving section 244a moves from a receive position (shown in FIG. 10A) at which the ink receiving section 244a is opposed to the ink ejection surfaces 5a to a non-receive position (shown in FIG. 12B) at which the ink receiving section 244a is not opposed to the same 5a. On the other hand, when the guide shaft 251 rotates in a direction opposite to the above-indicated prescribed direction, the support member 262 and the wiper 261 are moved from the left to the right in FIGS. 10A and 10B along the guide shafts 251, 252 and the ink receiving section 244a moves from the non-receive position to the receive position at the maintenance position of the maintenance unit 271. On this occasion, the sheet 241 is automatically unrolled or unwound from the roller 232 in accordance with the movement of the support member 262.

A cleaning member 275 as a cleaning device is provided in the tray 271 for removing the ink attached to the ink receiving section 244a of the sheet 241. The cleaning member 275 is fixed to the side wall 271c extending in the sub scanning direction in the vicinity of the roller 231, and is disposed such that one surface thereof is constantly held in contact with the outer surface 244 of the sheet 241. The cleaning member 275 is made of a porous member such as a sponge to remove the ink attached to the ink receiving section 244a by absorbing the ink.

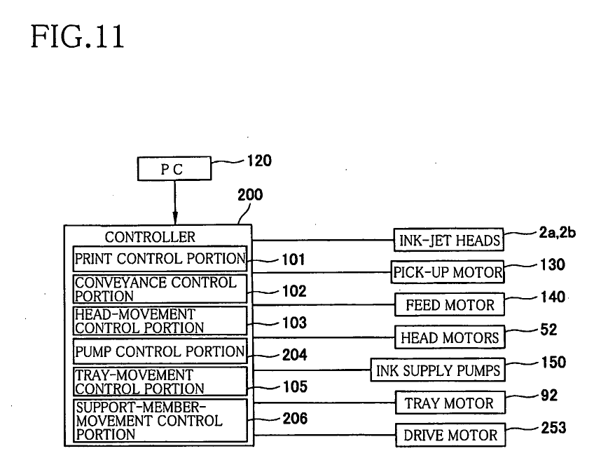

Referring next to the block diagram of FIG. 11, there will be explained a control system of the ink-jet printer according to the second embodiment. The ink-jet printer has a controller 200 for controlling the operations of the printer. The same reference numerals as used in the illustrated first embodiment are used to identify the corresponding components in the second embodiment, and a detailed explanation thereof is dispensed with. Like the controller 100 in the first embodiment, the controller 200 includes the print control portion 101, the conveyance control portion 102, the head-movement control portion 103, a pump control portion 204, the tray-movement control portion 105, and a support-member-movement control portion 206.

The pump control portion 204 is configured to control the ink supply pumps 150 to forcibly supply the ink from the ink tanks (not shown) to the respective ink-jet heads 2a, 2b for ejecting the ink from the nozzles 5b, when the controller 200 receives the maintenance signal from the external device such as the PC.

The support-member-movement control portion 206 as a sheet-member-movement controller is configured to control the drive motor 253 to move the support member 262 such that the ink receiving section 244a is moved between the receive position and the non-receive position, when the maintenance unit 270 is located at the maintenance position. On this occasion, the wiper 261 is also moved with the support member 262 and the sheet 241, thereby wiping the ink ejection surfaces 5a and the filler plates 28a, 28b.

Referring next to FIGS. 12A-12C, the maintenance operation performed by the maintenance unit 270 will be explained. FIGS. 12A-12C are views chronologically showing a purging operation performed on the ink-jet heads 2a, 2b and a wiping operation in which the ink ejection surfaces 5a and the bottom surfaces of the filler plates 28a, 28b are wiped.

As in the illustrated first embodiment, the maintenance signal is sent from the PC 120 to the controller 200 by a user's operation when the ink-jet heads 2a, 2b suffer from ejection failure or the like. When the controller 200 receives the maintenance signal, the head-movement control portion 103 drives the head motors 52 to move upward the head unit 4 from the print position to the head maintenance position (shown in FIG. 12C).

Subsequently, the tray-movement control portion 105 drives the tray motor 92 to move the maintenance unit 270 from the retracted position to the maintenance position. Since the sheet 241 is stopped with the ink receiving section 244a thereof located at the receive position, the ink receiving section 244a is opposed to the ink ejection surfaces 5a (ink ejection regions 5c) of the eight ink-jet heads 2a, 2b when the maintenance unit 270 reaches the maintenance position. After the maintenance unit 270 has been placed at the maintenance position, the head-movement control portion 103 controls the head motors 52 to move the head unit 4 downward such that the ink ejection surfaces 5a and the ink receiving section 244a approach relative to each other to an extent not to contact each other. In this instance, since the wiper 261 is located at a position where the wiper 261 is not opposed to the bottom surface of the head unit 4, the ink ejection surfaces 5a and the ink receiving section 244a can approach relative to each other to an extent not to contact each other, as in the illustrated first embodiment, namely, the ink ejection surfaces 5a can be disposed such that a distance between the ink ejection surfaces 5a and the outer surface 244 of the sheet 241 is made smaller than that when the wiper 261 wipes the ink ejection surfaces 5a. Accordingly, when the ink is ejected to the ink receiving section 244a as described below, the ink mist is less likely to drift in the air.

Subsequently, the pump control portion 204 drives the ink supply pumps 150 for a prescribed time to eject the ink from the ink-jet heads 2a, 2b to the ink receiving section 244a for the purging operation, After the ink ejection from the ink-jet heads 2a, 2b has been completed, the head-movement control portion 130 drives the head motors 52 to move the head unit 4 up to a position where the ink ejection surfaces 5a and the bottom surfaces of the filler plates 28a, 28b are capable of contacting the leading end of the wiper 261, as shown in FIG. 12A. On this occasion, the ink ejection surfaces 5a are disposed such that the distance between the ink ejection surfaces 5a and the outer surface 244 of the sheet 241 is made larger than that when the purging operation is performed.

Subsequently, the support-member-movement control portion 206 drives the drive motor 253 to move the wiper 262 from the right to the left for wiping the ink ejection surfaces 5a and the bottom surfaces of the filler plates 28a, 28b, as shown in FIG. 12B. In accordance with the movement of the wiper 261, the sheet 241 moves while being rolled or wound by the roller 232 and the ink receiving section 244a is moved from the receive position to the non-receive position. Further, on this occasion, the cleaning member 275 contacts the ink receiving section 244a that is being moved from the receive position to the non-receive position, whereby the ink attached to the ink receiving section 244a is removed by the cleaning member 275.

When the wiper 261 reaches a position at which the wiper 261 is not opposed to the ink ejection surfaces 5a and the filler plates 28a, 28b, the support-member-movement control portion 206 stops driving of the drive moor 253. On this occasion, the ink receiving section 244a located at the non-receive position is not covered with any section of the sheet 241 as in the illustrated first embodiment, so that the ink attached to the ink receiving section 244a does not attach to the inner surface of other sections of the sheet 241 except the ink receiving section 244a. Accordingly, it is possible to avoid the operation failure of the sheet 241. Thus, the wiping operation of wiping the ink ejection surfaces 5a (ink ejection regions 5c) of the eight ink-jet heads 2a, 2b is completed.

Thereafter, the head-movement control portion 103 drives the head motors 52 to move the head unit 4 up to the head maintenance position as shown in FIG. 12C, and the support-member-movement control portion 206 drives the drive motor 253 to move the sheet 241 such that the ink receiving section 244a is moved from the non-receive position back to the receive position. In accordance with the movement of the sheet 241, the sheet 241 rolled or wound around the roller 232 is unrolled or unwound therefrom. Further, the ink receiving section 244a and the cleaning member 275 contact each other to remove the ink from the ink receiving section 244a.

Subsequently, the tray-movement control portion 105 drives the tray motor 92 to move the maintenance unit 270 from the maintenance position to the retracted position. Then the head-movement control portion 103 drives the head motors 52 to move the head unit 4 downward from the head maintenance position to the print position. Thus, the maintenance operation is completed.

While the preferred embodiments of the invention have been described for the illustrative purpose only, it is to be understood that the invention may be otherwise modified within the scope of the invention defined in the attached claims.

In the illustrated embodiments, the belts 33, 34 and the sheet 241 are moved in the main scanning direction in the maintenance operation. The belts 33, 44 and the sheet 241 may be moved in the sub scanning direction. In this instance, the wipers and the like may be configured to be moved also in the sub scanning direction. While each of the ink-jet printers of the illustrated embodiments has the eight ink-jet heads 2a, 2b, the ink-jet printer may have a single ink-jet head. Where the ink-jet printer has a plurality of ink-jet heads, the heads may not be arranged in a zigzag fashion. The plurality of filler plates 28a, 28b may be constituted by a single plate member in which the plurality of filler plates are connected to each other. Further, the filler plates 28a, 28b may be eliminated. In this instance, the wiping members 62, 82 in the illustrated first embodiment for wiping the bottom surfaces of the filler plates 28a 28b may be eliminated. In the illustrated first embodiment, each of the wiping members 61, 62, 81, 82 has the two wipers. Each wiping member may have a single wiper. Further, the back-up members 66, 67 may be eliminated. Moreover, the inward recesses 64a, 65a of the wipers 64, 65 may not be provided.

In each of the illustrated embodiments, the principle of the invention is applied to the ink-jet printer having a plurality of ink-jet heads for ejecting the ink from the nozzles. The principle of the invention may be applied to various sorts of liquid ejecting apparatus such as those for ejecting an electrically conductive paste on a substrate to form fine wiring patterns thereon, those for ejecting an organic luminant on a substrate to form a high-definition display, and for ejecting an optical resin on a substrate to form a micro electronic device such as an optical waveguide.

What is claimed is:

1. A liquid ejecting apparatus, comprising:
a liquid ejecting head having an ejection surface in which is formed a liquid ejection region that includes a plurality of ejection openings through which a liquid is ejected;
a maintenance unit including: a roller rotatable about a rotational axis which is parallel to the ejection surface; a sheet member wound around the roller and having a liquid receiving section by which the liquid ejected from the plurality of ejection openings is received; a sheet-member moving mechanism configured to move the sheet member; and a wiper which protrudes from an outer surface of the sheet member and which is configured to wipe the ejection surface while moving in a first direction that is parallel to the ejection surface, in accordance with a movement of the sheet member;
a maintenance-unit moving mechanism configured to move the maintenance unit between (a) a maintenance position at which the liquid receiving section is capable of facing the ejection surface and (b) a retracted position at which the liquid receiving section is not capable of facing the ejection surface;
a maintenance-unit controller configured to control the maintenance-unit moving mechanism such that the maintenance unit is moved between the maintenance position and the retracted position; and
a sheet-member-movement controller configured to control the sheet-member moving mechanism such that the liquid receiving section of the sheet member is moved between a receive position at which the liquid receiving section faces the liquid ejection region and a non-receive position at which the liquid receiving section does not face the liquid ejection region, when the maintenance unit is located at the maintenance position,
wherein, when the maintenance unit is located at the maintenance position, the liquid receiving section is moved from the receive position to the non-receive position without being covered with the sheet member per se while the wiper wipes the liquid ejection region.

2. The liquid ejecting apparatus according to claim 1,
wherein the sheet-member moving mechanism includes a drive roller that is located distant from the roller in the first direction, and
wherein the sheet member is an endless belt wound around the roller and the drive roller and is moved by rotation of the drive roller.

3. The liquid ejecting apparatus according to claim 1, wherein, when the liquid receiving section is located at the receive position, the wiper is located at one of: (a) a section of the sheet member that cooperates with the ejection surface to interpose the liquid receiving section therebetween; and (b) a section of the sheet member that intersects the liquid receiving section.

4. The liquid ejecting apparatus according to claim 1, wherein the sheet-member-movement controller is configured to control the sheet-member moving mechanism such that the liquid receiving section is moved back toward the receive position after having been moved from the receive position to the non-receive position.

5. The liquid ejecting apparatus according to claim 1, wherein the maintenance unit includes, in addition to the wiper as a first wiper, a second wiper which protrudes from the outer surface of the sheet member and which is disposed adjacent to the first wiper.

6. The liquid ejecting apparatus according to claim 5,
wherein one of the first wiper and the second wiper is disposed downstream of the other of the first wiper and the second wiper in a wiper moving direction in which the first wiper and the second wiper move to wipe the ejection surface, and
wherein said one of the first wiper and the second wiper is configured to deflect more largely than the other of the first wiper and the second wiper that is disposed upstream of said one of the first wiper and the second wiper in the wiper moving direction.

7. The liquid ejecting apparatus according to claim 6,
wherein the maintenance unit further includes two back-up members which are disposed to sandwich the first wiper and the second wiper therebetween, so that said one of the first wiper and the second wiper that is disposed downstream of the other of the first wiper and the second wiper in the wiper moving direction is deflected more largely than the other of the first wiper and the second wiper that is disposed upstream of said one of the first wiper and the second wiper in the wiper moving direction.

8. The liquid ejecting apparatus according to claim 1, wherein the maintenance unit further includes a tray which receives the liquid ejected to the liquid receiving section from the liquid receiving section.

9. The liquid ejecting apparatus according to claim 8, wherein the tray is equipped with a cleaning device which cleans the liquid off the liquid receiving section.

10. The liquid ejecting apparatus according to claim 9, wherein the cleaning device includes a removing member to remove the liquid attached to the liquid receiving section and a storage portion to store the liquid removed from the liquid receiving section by the removing member.

11. The liquid ejecting apparatus according to claim 10, further comprising a discharging device which discharges the liquid stored in the storage portion and a waste-liquid accommodating portion which accommodates the liquid discharged by the discharging device.

12. The liquid ejecting apparatus according to claim 1, comprising a plurality of liquid ejecting heads each as the liquid ejecting head which are arranged in two rows in a zigzag fashion, each row extending in a second direction that is perpendicular to the first direction,
wherein the maintenance unit includes a plurality of rollers each as the roller, a plurality of sheet members each as the sheet member, and a plurality of wipers each as the wiper, the plurality of rollers, the plurality of sheet members, and the plurality of wipers respectively corresponding to the plurality of liquid ejecting heads, and
wherein the sheet-member moving mechanism is configured to move two of the plurality of sheet members such that corresponding two of the plurality of wipers that are for corresponding two of the plurality of liquid ejecting heads which belong to one and the other of the two rows and which are adjacent to each other in the second direction move in mutually opposite directions each as the first direction while contacting respective ejection surfaces of the corresponding two of the plurality of liquid ejecting heads.

13. The liquid ejecting apparatus according to claim 12, further comprising a plurality of plate members each of which is disposed so as to overlap, as viewed in the first direction, a corresponding one of a part of the plurality of liquid ejecting heads that belong to one of the two rows and so as to overlap, as viewed in the second direction, a rest of the plurality of liquid ejecting heads that belong to the other of the two rows, and
wherein the maintenance unit further includes a plurality of plate wipers each of which protrudes from the outer surface of a corresponding one of the plurality of sheet members that is for a corresponding one of the plurality of liquid ejecting heads and each of which wipes a corresponding one of the plurality of plate members that overlaps, as viewed in the first direction, the corresponding one of the plurality of liquid ejecting heads.
